(19) United States
(12) Patent Application Publication
(10) Pub. No.: US 2002/0073500 A1
(43) Pub. Date: Jun. 20, 2002

(54) Guide for paint roller

(76) Inventor: Theodoros Pavlou, Toronto (CA)

Correspondence Address: DENNISON ASSOCIATES, 133 Richmond Street West, Toronto, ON, M5H 2L7, CA

(21) Appl. No.: 09/761,676

(22) Filed: Jan. 18, 2001

(30) Foreign Application Priority Data
Dec. 15, 2000 (CA) 2,327,544

(51) Int. Cl. B05C 17/02

(52) U.S. Cl. 15/230.11; 492/13

(57) ABSTRACT

The present invention relates to an apparatus to provides a paint roller comprising an axle on which can be mounted an applicator roll said axle having first and second end caps rotatably mounted on said axle. The improvement provided by the present invention is the provision of guide means for attachment to the second end cap, said guide means having a first closed end and a second end attached to the second end cap of said paint roller. The closed end has one or more apertures and spring biased bearing means mounted in said guide means wherein the bearing means project through said apertures to guide said paint roller along a surface.

### BACKGROUND OF THE INVENTION

1. Field of the Invention

This invention relates to paint rollers. In particular the present invention provides an improved paint roller that when painting an interior surface is guided along an adjoining surface to result in a clear line at the edge of the first surface.

2. Description of the Prior Art

Painting an interior surface is typically accomplished using a brush, pad or roller. Usually the ceiling and trim around doors, windows and other openings are painted a different colour from the walls. Rollers make the job of painting large surfaces such as walls or ceilings quicker and generally result in a better finish than a brush or pad. However a brush is typically required to paint in corners and along the edges of adjoining walls, ceilings and trim as rollers typically cannot reach into angles or corners. This results in the need to paint a strip about 50 mm wide around the outside edge of adjoining surfaces with a brush which can be time consuming. Attempts to use the roller in an effort to save time can result in paint getting on the adjoining surface that is not being painted if the end of the roller accidentally makes contact with the adjoining surface. This is not uncommon due to slight defects or unevenness in the surfaces. A number of specialized tools have been developed to address the problem.

U.S. Pat. No. 2,936,474 illustrates a paint applicator for painting the adjoining faces of walls and ceilings. The device has a pair of rollers mounted on a platform that are in rolling contact with the ceiling. These rollers are fixed in place and are not spring biased. They help guide the applicator and the attached conical paint roller, along the line of contact between the ceiling and the wall.

U.S. Pat. No. 3,023,433 discloses a frusto-conical paint roller utilizing a spacer roller mounted at the end of the paint roller. The spacer roller projects a small distance above the paint roller where it engages the ceiling and ensures the spacing of the paint roller from the ceiling. The spacer roller is mounted on a spring biased pivot arm.

U.S. Pat. No. 3,213,477 discloses a guide for attachment to a typical paint roller. Wheels are attached to the guide to assist with guiding it along the wall. The paint roller is connected to the guide plate and bar spring urges the roller into position.

However, there is a need for a simple solution that provides a single roller that can be used to paint the large surface areas without the need for a brush, pad or other specialized tool to paint along the edges of adjoining surfaces or trim.

### SUMMARY OF THE INVENTION

It is an object of the invention to provide an improved paint roller that when painting an interior surface is guided along an adjoining surface to result in a clear line at the edge of the first surface.

It is a further object of the invention to provide guide means for a paint roller.

It is a further object of the invention to provide a paint roller that can be moved in a horizontal direction across a vertical surface while applying pressure to maintain the end of the paint roller against an adjoining horizontal surface.

Thus in accordance with one embodiment of the present invention there is provided guide means for attachment to the free end of a paint roller. The guide means has a first closed end and a second end attached to the free end of the paint roller. The closed end has one or more apertures. Spring biased bearing means are mounted in said guide means so that the bearing means projecting through said apertures to guide said paint roller along a surface.

Another embodiment of the present invention provides a paint roller comprising an axle on which can be mounted an applicator roll said axle having first and second end caps rotatably mounted on said axle. The improvement provided by the present invention is the provision of guide means for attachment to the second end cap, said guide means having a first closed end and a second end attached to the second end cap of said paint roller. The closed end has one or more apertures and spring biased bearing means mounted in said guide means wherein the bearing means project through said apertures to guide said paint roller along a surface.

In a further embodiment of the present invention a paint roller is provided wherein the distal end of the rod is threaded to permit a handle to be attached to the rod. A second threaded rod section is provided depending at an angle of 30° so that when the handle is attached to said second threaded rod section the paint roller can be easily rolled in a horizontal direction while maintaining the guide means against the adjoining surface.

Further features of the invention will be described or will become apparent in the course of the following detailed description.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a perspective view of a paint roller according to the present invention;

FIG. 2 is a cross section of the guide means of the paint roller of FIG. 1 with an applicator roll shown in dotted lines;

FIG. 3 is a right end plan view of the guide means of FIG. 2;

FIG. 4 is a perspective view of another embodiment of a paint roller according to the present invention.

### DETAILED DESCRIPTION OF THE PREFERRED EMBODIMENT

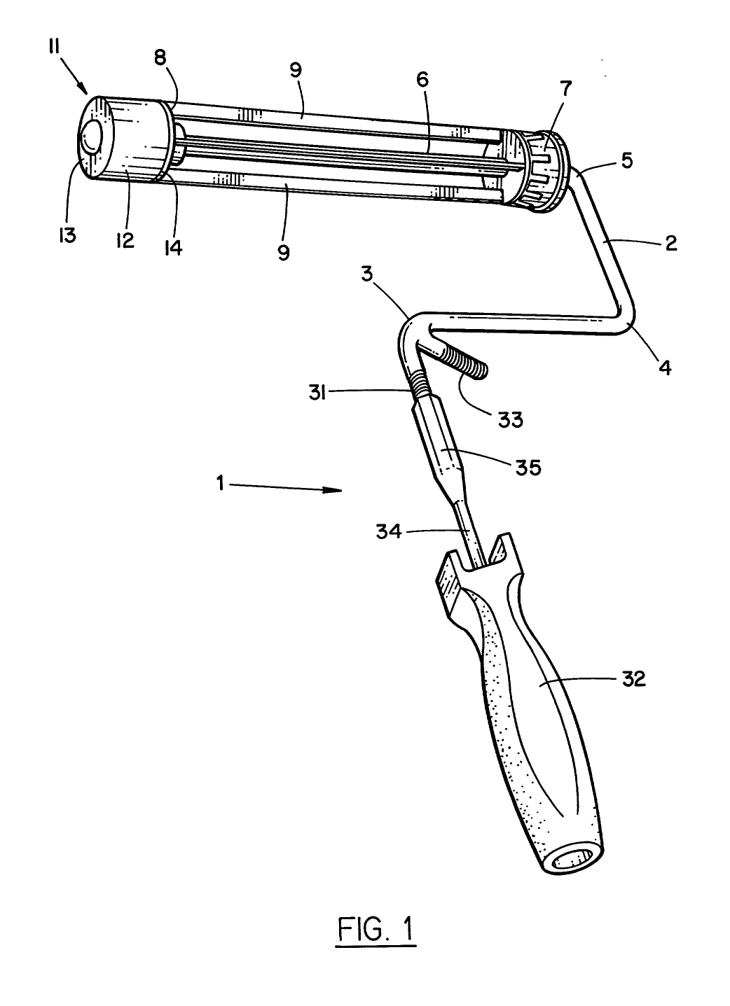

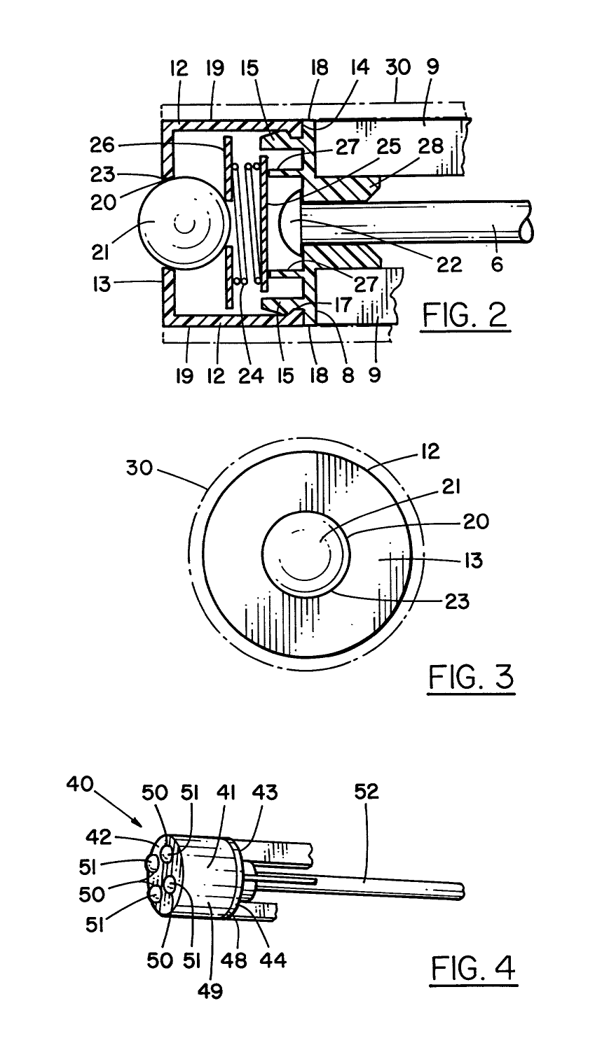

Referring to FIGS. 1 to 3, a paint roller according to one embodiment of the present invention is generally indicated at 1. The paint roller 1 consists of a rod 2 which is bent at right angles three times at points 3, 4 and 5 terminating in axle 6 on which can be mounted an applicator roll 30 (not shown in FIG. 1 but shown in dotted lines in FIG. 2 and 3). The applicator roll 30 is conventionally a cardboard tube having a pile or foam covering on its exterior surface for application of the paint to the surface along which the applicator is rolled. The axle 6 is provided with first and second end caps 7, 8 respectively, that are rotatably mounted on axle 6. The first and second end caps 7, 8 may be independent of each other or connected by a series of ribs 9. The applicator roll is typically slid over the second end cap 8 and is held in place by the frictional fit between the applicator roll 30 and first and second end caps 7, 8 and ribs 9, if provided. The ribs 9 can be either rigid or flexible.

According to the present invention, a guide means 11 is provided in association with end cap 8 to guide the paint roller along the intersection between adjoining surfaces such as a wall and ceiling. One embodiment of the guide means 11 according to the present invention is illustrated in FIGS. 1 to 3. The Guide means 11 has a cylindrical side wall 12 and a closed end 13. The other end 14 of guide means 11 is attached to end cap 8. In the embodiment shown end cap 8 is provided with a cylindrical side wall 15 having a recessed portion 17 at the outside edge 18 of end cap 8. The open end 14 of guide means 11 fits over the recessed portion 17 of end cap 8 and is attached by a mechanical connection (as illustrated in FIG. 2), by an adhesive or other suitable fastening means. When attached the exterior surface 19 of side wall 12 of guide means 11 is even with the exterior surface 18 of end cap 8.

Centrally disposed in closed end 13 of guide means 11 is aperture 20. Mounted within guide means 11 and projecting through aperture 20 is rotatable bearing 21. Bearing 21 is spherical in shape with a diameter greater than the diameter of aperture 20. The bearing 21 is spring biased between the end 22 of axle 6 and the edge 23 of aperture 20 by spring 24 or other suitable biasing means. In the preferred embodiment illustrated, a first washer 25 is provided between spring 24 and the end 22 of axle 6. The first washer 25 rests on a raised circular rib 27 that surrounds the end 22 of axle 6. A second washer 26 is provided between spring 24 and the bearing 21. The washers 25 and 26 provide support for the spring 24. Hub 28 is centrally disposed on end cap 8 and projects inwardly therefrom to provide the means of connection of end cap 8 to axle 6.

To paint along the edge of a surface that adjoins another surface, for example the top of the wall at the junction with the ceiling, paint roller 1 is rolled horizontally along the top edge of the wall with the bearing 21 pushed against and rolling along the ceiling. Bearing 15 permits the roller to be rolled along the top of the wall and guides the paint roller so that a clean line of paint is applied on the wall about 2 to 3 mm of the ceiling but not on the ceiling. Because the bearing 21 is spring biased it will follow any imperfections in the ceiling.

FIG. 4 illustrates another embodiment of a guide means according to the present invention. In this embodiment guide means 40 has a cylindrical side wall 41 and a closed end 42. The other end 43 of guide means 40 is attached to the end cap 44 of the paint roller. In the embodiment shown end cap 44 is provided with a cylindrical side wall having a recessed portion at its outside edge similar to FIG. 2. The open end 43 of guide means 40 fits over the recessed portion of end cap 44 and is attached by a mechanical connection, an adhesive or other suitable fastening means. When attached the exterior surface 49 of side wall 41 of guide means 40 is even with the exterior surface 48 of the end cap 44.

In closed end 42 of guide means 40 is a series of apertures 50. Mounted within guide means 40 and projecting through said apertures are a plurality of rotatable bearings 51. Bearings S1 are spherical in shape with a diameter greater than the diameter of apertures 50. The bearings 51 are spring biased between the end of axle 52 and the edge of the apertures 50 by a spring or other suitable biasing means similar to the arrangement shown in FIG. 2. In the preferred embodiment illustrated, a first washer is provided between the spring and the end of the axle. A second washer is provided between the spring and the bearings. The washers provide support for the spring. The use of multiple small dimension bearings 51 permit the roller to be used not only against wide adjoining surfaces such as ceilings, but against narrower surfaces such as mouldings around doors, windows or other openings.

Referring to FIG. 1, the distal end 31 of rod 2 remote from axle 6 is threaded to permit a handle 32 to be attached to the rod. Handle 32 is equipped with a co-axial rod section 34 one end of which is inserted into handle 32 and the other end 35 is provided with a female threaded connection for attachment to the end 31 of rod 2. At bend 3, a second threaded rod section 33 is provided depending at an angle 30° from bend 3. When handle 32 is unscrewed from the end 31 of rod 2 and attached to second threaded rod section 33 the paint roller can be easily manipulated as it is rolled along the top edge of the wall without causing undue strain on the arm and without the need for a ladder.

Having illustrated and described a preferred embodiment of the invention and certain possible modifications thereto, it should be apparent to those of ordinary skill in the art that the invention permits of further modification in arrangement and detail. All such modifications are covered by the scope of the invention.

The embodiments of the invention in which an exclusive property or privilege is claimed are defined as follows:

1. Guide means for attachment to the free end of a paint roller, said guide means having a first closed end and a second end attached to the free end of said paint roller, said closed end having one or more apertures and spring biased bearing means mounted in said guide means, said bearing means projecting through said apertures to guide said paint roller along a surface.

2. Guide means according to claim 1 wherein said closed end has a centrally disposed aperture.

3. Guide means according to claim 2 wherein mounted within said guide means is a spherical bearing having a diameter greater than the diameter of said aperture said bearing spring biased to project through said aperture.

4. Guide means according to claim 1 wherein said closed end has a series of apertures.

5. Guide means according to claim 4 wherein mounted within said guide means are a plurality of spherical bearings with a diameter greater than the diameter of said apertures said bearings spring biased to project through said apertures.

6. A paint roller comprising an axle on which can be mounted an applicator roll said axle having first and second end caps rotatably mounted on said axle the improvement comprising guide means for attachment to the second end cap, said guide means having a first closed end and a second end attached to the second end cap of said paint roller, said closed end having one or more apertures and spring biased bearing means mounted in said guide means, said bearing means projecting through said apertures to guide said paint roller along a surface.

7. A paint roller according to claim 6 wherein said guide means has a cylindrical side wall and said second end cap has a cylindrical side wall having a recessed portion at its outside edge wherein the open end of guide means fits over the recessed portion of end cap and is attached by an adhesive or other suitable fastening means.

8. A paint roller according to claim 7 wherein the exterior surface of side wall of guide means is level with the exterior surface of the side wall of end cap.

9. A paint roller according to claim 8 wherein said closed end of said guide means has a centrally disposed aperture and mounted within said guide means is a spherical bearing having a diameter greater than the diameter of said aperture said bearing spring biased to project through said aperture.

10. A paint roller according to claim 8 wherein said closed end of said guide means has a series of apertures and mounted within said guide means are a plurality of spherical bearings with a diameter greater than the diameter of said apertures said bearings spring biased to project through said apertures.

11. A paint roller according to claim 6 wherein the distal end of said rod is threaded to permit a handle to be attached to the rod.

12. A paint roller according to claim 11 wherein a second threaded rod section is provided depending at an angle 30° so that when handle is attached to said second threaded rod section.
